(19) United States
(12) Patent Application Publication
(10) Pub. No.: US 2025/0353743 A1
(43) Pub. Date: Nov. 20, 2025

(54) ALLOY MATERIALS AND RELATED METHODS FOR PROCESSING HYDROGEN SULFIDE

(71) Applicant: SAUDI ARABIAN OIL COMPANY, Dhahran (SA)

(72) Inventors: Rajesh Kumar SAINI, Cypress, TX (US); Sehmus OZDEN, Katy, TX (US)

(73) Assignee: SAUDI ARABIAN OIL COMPANY, Dhahran (SA)

(21) Appl. No.: 18/663,530

(22) Filed: May 14, 2024

(51) Int. Cl. C01B 17/04

(52) U.S. Cl. CPC C01B 17/0434; C01B 2203/0277; C01B 2203/1058; C01B 2203/1235; C01B 2203/1258

(57) ABSTRACT

A multi-metal composition and a method utilizing the multi-metal composition is disclosed. The multi-metal composition may comprise: an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr. The method may comprise: providing a multi-metal composition comprising an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr; and interacting a gas stream comprising hydrogen sulfide with the multi-metal composition.

### FIELD

The present disclosure generally relates to multi-metal compositions comprising alloys and, more particularly, the use of the multi-metal compositions for converting hydrogen sulfide into hydrogen and sulfur.

### BACKGROUND

Hydrogen sulfide is a toxic and corrosive gas that is widely generated in the petroleum industry during the production of hydrocarbons. In a formation, it may be produced through various processes: one of which is the breakdown of organic sulfur compounds by sulfate-reducing bacteria. In other instances, it is produced by certain acidic fracturing fluids when they react with certain rock formations (e.g., iron sulfide) to generate hydrogen sulfide gas downhole. Some hydrogen sulfide is also produced in the refining of crude oil. The classes of compounds responsible for hydrogen sulfide formation in crude oil refining and upgrading may be thiols, thioethers, disulfides and heterocyclic sulfides (e.g., thiophenes, dibenzothiophenes, and the like). Once hydrocarbon is produced along with hydrogen sulfide, it may be necessary to remove it from crude oil or natural gas to make it suitable for commercial use. Hydrogen sulfide may be found together with methane, hydrogen and higher hydrocarbons, and traces of nitrogen-, oxygen-, calcium-, and metal-containing species which complicate the selection of the most suitable hydrogen sulfide mitigation techniques. When natural gas and hydrogen sulfide is produced as part of oil extraction, operators often vent or flare the gas to get rid of it.

Various techniques exist for splitting hydrogen sulfide into sulfur and hydrogen, which are two valuable commodities with wide applicability. However, large-scale hydrogen production processes from hydrogen sulfide have not yet been developed. Nonoxidative hydrogen sulfide decomposition is a potential strategy to overcome the drawbacks of oxidative schemes as it yields high-purity hydrogen and has higher energy efficiency in sulfur recovery compared to oxidative schemes. However, direct hydrogen sulfide thermal or catalytic decomposition in the gaseous phase is highly endothermic, and its reversible nature severely limits the equilibrium conversion.

Known non-catalytic thermal processes to decompose hydrogen sulfide to hydrogen and sulfur require high temperatures and still have low overall conversion. To obtain a reasonable yield and conversion, significant capital cost would be required if such process could be made practical. In addition, a recycle feedback loop would be required to use the other unreacted hydrogen sulfide along with a purification step for the separation of hydrogen sulfide from hydrogen. Known catalytic thermal processes may lower the operating temperature, but yields are still lower, and the final product needs to be separated to prevent the equilibrium reaction from happening. Given this, there is a need for a better process and a more efficient catalyst to produce hydrogen from hydrogen sulfide at better conversions and lower temperatures.

### SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more aspects, the present disclosure provides a method comprising: providing a multi-metal composition comprising an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr; and interacting a gas stream comprising hydrogen sulfide with the multi-metal composition.

In another aspect, the present disclosure provides a method comprising: providing a multi-metal composition comprising CrFeWNiMo, CrFeZnTiMo, MoNiCuZnCo, CrFeNiVMo, or CuFeNiVMo sulfide; and interacting a gas stream comprising hydrogen sulfide with the multi-metal composition.

In yet another aspect, the present disclosure provides a multi-metal composition comprising: an alloy comprising at least five elements selected from the group consisting of Co, Cr, Fc, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one having ordinary skill in the art and having the benefit of this disclosure.

FIG. 1 shows a continuous method of converting hydrogen sulfide into hydrogen and sulfur after passing through a column containing a multi-metal composition and separation of components using different equipment in thermocatalytic and/or thermochemical processes. The process may or may not include regeneration of the multi-metal composition. The method is a thermocatalytic and/or thermochemical decomposition method.

FIG. 2 shows a method of converting hydrogen sulfide into hydrogen and sulfur in a two-step process. In the first step, H₂S is passed through a multi-metal composition at low temperature to generate hydrogen and sulfidize the multi-metal composition. In the second step, when the multi-metal composition is fully or partially sulfidized, it is regenerated by heating at a higher temperature to generate and collect sulfur and regenerate the multi-metal composition for further H₂S conversion to hydrogen. This method is thermochemical decomposition of H₂S.

FIG. 3 shows the performance of a MoNiCuZnCo oxide alloy versus other compounds.

FIG. 4 shows a sulfidation equation from the present disclosure.

FIG. 5 shows a regeneration equation from the present disclosure.

### DETAILED DESCRIPTION

The present disclosure generally relates to multi-metal compositions comprising alloys and, more particularly, the use of the multi-metal compositions for converting hydrogen sulfide into hydrogen and sulfur.

Many transition and heavy metal catalysts have been investigated for use in thermal decomposition reactions; however, none are efficient enough in terms of overall conversion and their high temperature requirements are too onerous for economical use.

Provided in this disclosure are multi-metal compositions comprising an alloy with at least four metals, and preferably at least five metals. The alloys of this disclosure may have high entropy compared to known catalysts with bi- or tri-metal components. However, no specific magnitude for entropy is intended by this description. The alloys of this disclosure may have outstanding chemisorption, physiochemical, surface, and electromagnetic properties, including extraordinary catalytic activity with reasonably good stability, which may be regulated by tuning the content of each metal depending on the need. The alloys may provide enhanced catalytic activity that may be controlled by rational tuning of composition, geometry, structure, and dimensionality. Alloys with at least four metals may have a vast number of atomic arrangements, surface microstructure with active elements, and/or active sites, which may be favorable to the adsorption of reactants and associated intermediates. The existence of atomically mixed elements in an alloy may lead to the modification of the electronic structure of the individual elements and hence, fine-tuning of the catalytic properties. The electronic structure of the alloys may be tuned by changing the composition, which may create lattice distortion. This may shift the d-band in the upward direction, which may improve the bonding between metals and molecules and reduce the adsorption energy required for the reactants or intermediates. The alloys of this disclosure may provide excellent catalytic performance toward several thermal-driven and electrocatalytic reactions.

The alloys may be used in multi-metal compositions to improve the efficiency and yield of the thermal catalytic process to decompose and convert hydrogen sulfide to hydrogen and sulfur at relatively low temperatures, with shorter residence times, and with higher yields in comparison to bi-metallic or tri-metallic catalyst.

The multi-metal composition may comprise a neat alloy or an alloy coated or mixed with the support material and optionally comprise at least one promoter. Optionally, the support, promoter, or both may be mixed with the alloy or the alloy may be coated or disposed on to the supported material. This mixture may be accomplished by a post-synthesis process.

The multi-metal compositions promote nonoxidative decomposition of H₂S as shown below in Equation A:

$${H}_{2} S ( g ) ↔ {H}_{2} ( g ) + 0.5 {S}_{2} ( g ) \qquad Eq . A$$

Further provided are methods comprising providing the multi-metal composition and interacting it with gas streams comprising hydrogen sulfide to separate the hydrogen and the sulfur. In some embodiments, the gas stream may include hydrogen sulfide and other chemicals such as natural gas, hydrocarbons, carbon dioxide, carbon monoxide, oxygen, nitrogen, or water. The alloy may be a metal alloy, metal alloy sulfide, metal alloy oxide or combination thereof. These metal alloy catalysts can also be supported on alumina, silica, bauxite, titania, zirconium, zeolites, carbides, nitrides or carbon materials including activated carbon, carbon nanotubes, or the like. The interaction may be a decomposition reaction in a thermocatalytic method or a sulfidation reaction in a thermochemical reaction wherein the alloy undergoes sulfidation. The thermocatalytic method may include providing a column on which the multi-metal composition is disposed, and after interaction with the multi-metal composition, condensing the sulfur, separating the hydrogen, or both to move the reaction forward. Thermochemical method may include providing a column on which the multi-metal composition is disposed, interacting the multi-metal composition with the hydrogen sulfide so that the multi-metal composition undergoes sulfidation. The thermochemical method may be performed at a lower temperature than the thermocatalytic method. After the multi-metal composition undergoes sulfidation, the column and the multi-metal composition disposed in the column may be regenerated at a higher temperature to remove at least some sulfur from the multi-metal composition.

The multi-metal composition may comprise an alloy comprising multiple elements. The alloy may have at least four elements, at least five elements, or at least six elements. Alloys comprising at least five metals may have high entropy compared to alloys with less metals. This may decrease the energy necessary to convert hydrogen sulfide to sulfur and hydrogen.

The alloy may include at least five transition metals, heavy metals such as Cd, Pb, Sn, Ga, Ge, In, Sb, Tl, and Bi, or noble metals such as Pt, Os, Pd, Ru, Rh, Ag, Ir, and Au, including combinations thereof. In some embodiments, the alloy may include at least five of Co, Cr, Fe, Mn, Ni, Al, Mg, Cu, Zn, Zr, Ru, Rh, Pd, Ag, W, Re, Ir, Pt, Pd, Au, Os, Ce, Yb, Sn, Ca, Be, Mo, V, W, Sr, Cd, Pb, Ga, Ge, In, Sb, TI, Bi, or the like. In some embodiments, the alloy may include at least five of Co, Cr, Fe, Mn, Ni, Al, Mg, Cu, Zn, Zr, Ru, Rh, Pd, Ag, W, Rc, Ir, Pt, Pd, Au, Cc, Yb, Sn, Ca, Be, Mo, V, W, or Sr. In some embodiments, the alloys may comprise CrFeWNiMo, CrFeZnTiMo, MoNiCuZnCo, CrFeNiVMo, or CuFeNiVMo.

The alloy may comprise at least five species, and the molar ratios may be equimolar or non-equimolar. Each species may be present in different or the same amount, where the range may be from about 5 atomic % to about 45 atomic %, about 15 atomic % to about 35 atomic %, about 15 atomic % to about 25 atomic %, about 18 atomic % to about 22 atomic %, or about 20 atomic %.

The alloy may be in the form of metal alloys, metal alloy sulfides, metal alloy oxides, or combinations thereof. The alloy may include secondary phases such as intermetallic phases, laves phases, carbides, borides, borocarbides, nitrides, silicide, aluminides, oxides, phosphides, phosphates, sulfides, sulfates, hydrides, hydrates, carbonitrides, graphene, graphene oxide, nanotubes, graphite, or combinations thereof.

The alloy may comprise at least one support on which the alloy may be coated, disposed on, or alloyed to. The support may be a metal sulfide or metal oxide. The type and composition of metal support may influence the alloy dispersion, sintering resistance, and facilitation of reactant adsorption. The support may prevent coke formation on the surface of the alloy. This may enable the alloy to remain active and stable for the hydrogen production. The support may comprise Al₂O₃, Al₂O₄, SiO₂, MgO, TiO₂, Fe₂O₄, FeO, ZrO₂, CeO₂, lanthanide oxides such as Er₂O₃, or combinations thereof. The support may also function as a promoter.

In some embodiments the support may be part of the alloy. In these embodiments the amount of support may be from about 0.01 atomic % to about 30 atomic %, about 0.01 atomic % to about 22 atomic %, about 0.01 atomic % to about 20 atomic %, about 18 atomic % to about 22 atomic %, about 1 atomic % to about 10 atomic %, or about 8 atomic % to about 10 atomic % based on the atomic total of the alloy.

In some embodiments the alloy may be coated or disposed on the support. In these embodiments the amount of alloy coated or disposed on the support may be from about 0.3 wt. % to about 12 wt. %, about 0.5 wt. % to about 10 wt. %, about 3 wt. % to about 7 wt. %, about 5 wt. % to about 10 wt. %, or about 8 wt. % to about 10 wt. % based on the weight of the supported alloy.

Promoters may be at least one of the at least five metal species chosen for the alloy. In other words, promoters may be incorporated into the alloy during the synthesis of the alloy. Alternatively, promoters may instead be mixed with the alloy and coated or disposed on to the surface of the support in one or more post-alloy-synthesis steps. Support, promoters, or both may be used with, but separate from, the alloy's crystal structure. For example, an alloy comprising CrFeZnTiMo may be connected and/or coated on the surface of a support particle such as alumina.

Promoters may improve the selectivity, durability, and activity of the alloy and thus limit coke formation, active site oxidation, sintering, or segregation. The promoters may include chemical or structural promoters. Chemical promoters may be used to improve the efficiency of the alloy as they may alter the distribution of electrons at the surface of the alloy. Structural promoters may be used to improve the mechanical properties of the catalyst system as they may prevent sintering. Inclusion of promoters and supporters may offer better adsorption and chemisorption sites for the reactants. This may improve the selectivity of the alloy and may enhance the efficiency and rate of reactions. The promoter may also function as a supporter. Promoters may include alkali metals such as Li, Na, Ca, K, Cs, and Fr, Fe, Co, Mn, Mg, Al, Ni, Mo, Cu, Pd, Pt, Ce, CeₓO_{y} such as Ce₂O₃, and CeO₂, Mg, MgO, Ca₂SiO₄, CaO, La, Nd, Gs, Re, and the like.

The amount of alloyed promoter may be from about 0.01 atomic % to about 30 atomic %, about 0.01 atomic % to about 22 atomic %, about 0.01 atomic % to about 20 atomic %, about 18 atomic % to about 22 atomic %, about 1 atomic % to about 10 atomic %, or about 8 atomic % to about 10 atomic % based on the atomic total of the alloy.

In some embodiments, the alloy comprises at least one metal support and at least one metal promoter. This may create improved interaction between active metals, support, and promoters as compared to different formulations.

In some embodiments, the support is not part of the synthesized alloy but is a separate support upon which the alloy is positioned, mixed, or coated. The support may be combined with the alloy through mixing and/or coating. The support in these embodiments may comprise alumina, silica, bauxite, titania, zirconium, zeolites, carbides, nitrides or carbon materials including activated carbon, carbon nanotubes, carbonitrides, graphene, graphene oxide, Al₂O₃/MgO or Al₂O₃/CeO₂, MgAl₂O₃, borides, borocarbides, nitrides, silicide, aluminides, oxides, phosphides, phosphates, sulfides, sulfates, hydrides, hydrates, and mixtures thereof. Support may include materials that are stable up to 1200° C. and do not interfere with the alloy's interaction with the hydrogen sulfide. In some embodiments, support may be stable up to 900° C.

In some embodiments, the promoter is not part of the alloy but is a separate promoter upon which the alloy is connected to. The promoter may be combined with the alloy through mixing. The promoter may show little or no catalytic effect. The promoters may cooperate with active components of alloys and change their chemical effect on a catalyzed substance. The interaction between alloy and promoter may lead to changes in the properties of alloy such as its electronic and crystal structures of active solid components of the alloy. Promoters may include alkali metals such as Li, Na, Ca, K, Cs, Fr, Fe, Co, Mn, Mg, Al, Ni, Mo, Cu, Pd, Pt CeO₂, MgO, Ca₂SiO₄, CaO, La, Nd, Gs, Re, carbides, borides, borocarbides, nitrides, silicide, aluminides, oxides, phosphides, phosphates, sulfides, sulfates, hydrides, hydrates, carbonitrides, graphene, graphene oxide, nanotubes, graphite or mixtures thereof.

In some embodiments, the alloy may be first synthesized with the at least four metal species for the alloy, and then subsequently a promoter may be mixed as to be dispersed within the alloy and then further mixed or coated on to a support. For example, MgO may be used as the promoter and Al₂O₃ may be used as the support. The mixing of rare earth elements with the alloy and the support may lead to the formation of a hydrotalcite-like structure that may improve the activity of the alloy's particles.

In some embodiments, one of the at least five species in the alloy is a metal promoter and the alloy is mixed and supported on support. The amount of alloy supported when the alloy is supported by a non-alloyed supporter may be from about 0.3 wt. % to about 12 wt. %, about 0.5 wt. % to about 10 wt. %, about 3 wt. % to about 7 wt. %, about 5 wt. % to about 10 wt. %, or about 8 wt. % to about 10 wt. % based on the weight of the supporter.

In some embodiments, one of the at least five species in the alloy is a metal support and the alloy is mixed and connected to a promoter upon which it is positioned. The amount of promoter connected to the alloy may be from about 0.1 wt. % to about 12 wt. %, about 0.5 wt. % to about 10 wt. %, about 3 wt. % to about 7 wt. %, about 5 wt. % to about 10 wt. %, or about 8 wt. % to about 10 wt. % based on the weight of the alloy and promoter composition.

The alloy particles may have a particle size from about 1 nm to about 250 micron, about 2 nm to about 200 micron, about 500 nm to about 100 micron, about 2 nm to about 100 nm, about 2 nm to about 50 nm, or about 2 nm to about 10 nm. Alloy particles with smaller particle sizes, such as below 100 nm, may have a higher reactivity and a lower temperature conversion of hydrogen sulfide as compared to larger particles. Particles under 100 nm may perform significantly better on alumina-, silica-, or carbon-based support. The alloy particles may comprise the shapes of generally spherical, generally cubic, generally tetrahedron-shaped, or combinations thereof. The alloys may comprise the crystalline structures of face centered cubic or body centered cubic.

The multi-metal compositions may be made through various techniques such as wet-chemical methods, sol-gel autocombustion methods, spray pyrolysis, carbothermal shock synthesis, hydrothermal methods, pulse-laser ablation, mechanical milling, arc melting, induction melting, metal spray techniques, molecular beam epitaxy (MBE), atomic layer deposition (ALD), chemical vapor deposition (CVD), pulsed laser deposition (PLD), or the like.

The composition of the alloys with chemical and physical properties of synthesized HEAs catalyst may be investigated using X-ray diffraction (XRD), X-ray photoelectron spectroscopy (XPS), scanning electron microscopy (SEM), high-resolution transmission electron microscopy (HRTEM), Atomic force microscopy (AFM), energy-dispersive X-ray spectrometry (EDX), BET-Surface area, Inductively Coupled Plasma Mass Spectrometry (ICP-MS), X-ray absorption coefficient, Fourier-transform infrared spectroscopy (FTIR), Dynamic Light Scattering (DLS), UV-vis Spectrometry, photoluminescence spectroscopy, mechanical properties by nanoindentation and dynamical mechanical analysis (e.g. hardness, modulus etc.).

The alloy may be synthesized via arc melting. Pure powders of metals such as Co, Cr, Fc, Mn, Ni, Al, Mg, Cu, Zn, Zr, Ru, Rh, Pd, Ag, W, Rc, Ir, Pt, Pd, Au, Os, Ce, Yb, Sn, Ca, Bc, Mo, V, W, Sr, Cd, Pb, Ga, Ge, In, Sb, TI, Bi, or the like may be used. The amounts of each metal may be equimolar or non-equimolar ratios. The metal powders may be arc melted with a tungsten electrode under an inert atmosphere such as argon on a cooled hearth such as a cooled copper hearth. This may form a polycrystalline button. The button may be turned and remelted multiple times. The ingot may be cooled with liquid nitrogen and may be milled with milling techniques such as cryo milling at lower temperatures such as −160° C. under an inert atmosphere to make a powder.

The alloy may be synthesized via mechanical alloying. The metals alloyed may include powders of Co, Cr, Fc, Mn, Ni, Al, Mg, Cu, Zn, Zr, Ru, Rh, Pd, Ag, W, Rc, Ir, Pt, Pd, Au, Os, Ce, Yb, Sn, Ca, Bc, Mo, V, W, Sr, Cd, Pb, Ga, Ge, In, Sb, TI, Bi, or the like. The powders may be from about 30 micron to about 50 micron. The amounts of each metal may be cquimolar or non-cquimolar ratios. The metal powders may be combined with a process control agent such as stearic acid or palmitic acid. The mixture may be mixed for at least 60 h in a planetary ball miller. The alloy formed may have a particle size ranging from about 0.1 micron to about 15 micron or about 0.5 micron to about 10 micron.

The alloy may be synthesized via solvo thermal reaction. The metals may include Co, Cr, Fc, Mn, Ni, Al, Mg, Cu, Zn, Zr, Ru, Rh, Pd, Ag, W, Rc, Ir, Pt, Pd, Au, Os, Ce, Yb, Sn, Ca, Bc, Mo, V, W, Sr, Cd, Pb, Ga, Ge, In, Sb, TI, Bi, or the like. The amounts of each metal may be equimolar or non-equimolar ratios. The metals may be complexed with bidentate ligands such as acetylacetonate, ethylene diamine, phenanthroline, or oxalate. The metal complexes may be dissolved in a mixture of acetone and methanol and heated to at least 150° C., at least 200° C., or a range from about 175° C. to about 225° C. The mixture may be placed in a scaled vessel for at least 24 h to react. After reaction, the solvent may be evaporated, the product washed with a nonpolar solvent such as hexane, and then heated to at least 150° C., at least 200° C., or from about 175° C. to about 225° C. under an argon atmosphere. Then, the alloy may be grinded to the required size for use with hydrogen sulfide.

The alloy may be synthesized via cation exchange reaction. The metals used may be Co, Cr, Fe, Mn, Ni, Al, Mg, Cu, Zn, Zr, Ru, Rh, Pd, Ag, W, Rc, Ir, Pt, Pd, Au, Os, Ce, Yb, Sn, Ca, Bc, Mo, V, W, Sr, Cd, Pb, Ga, Ge, In, Sb, TI, Bi, or the like. The method may include providing a metal sulfide such as copper sulfide in a solvent. The solvent for the metal sulfide may comprise a long chain and a phosphide or an amine such as trioctyl phosphine or trioctyl amine. To the metal sulfide are added the other metal salts that will form the eventual alloy. The amounts of each metal used may be equimolar or non-equimolar ratios. In various embodiments, the molar ratio ranges from about 0.01 M to about 0.03 M or about 0.02 M. The metal salts may be halogen salts such as chlorides or nitrates. The metal salts may be dissolved in suitable organics. Suitable organics may include (A) long chain mono unsaturated fatty acids such as linoleic acid, oleic acid, or palmitoleic acid or long chain amines with an internal double bond such as oleyl amine; (B) long chain alkenes with at least one internal double bond such as octadecene and nonadecene, and (C) ethers such as benzyl ether, di-tert-butyl ether, di-isopropyl ether or amines such as benzamine, di-tert butyl amine, di-isopropyl amine. Long chain molecules may include at least 6 carbons, at least 12 carbons, or at least 18 carbons. The molar ratio of A:B:C may range from about 1.5 to 2.5 of A: about 0.5 to about 1.5 of B: about 0.5 to about 1.5 of C. The mixture may be stirred, placed under vacuum, and heated to a range from about 70° C. to about 150° C., about 90° C. to about 110° C., or about 100° C. for at least 30 min or about 30 min. The reaction mixture may be cycled at least three times under argon and a vacuum, and then put under an argon blanket. Then, under an argon blanket the mixture may be reacted at a temperature range from about 110° C. to about 170° C., about 130° C. to about 150° C., or about 140° C. for at least 60 min or about 60 min. The reaction mixture may then be chilled in an ice bath to no greater than about 20° C. or no greater than about 10° C., or from about 10° C. to about 20° C. The reaction mixture then may be subjected to a washing procedure comprising mixing with a reaction mixture of polar solvents such as isopropanol and acetone, centrifuged, and suspended in a nonpolar solvent such as toluene. The washing procedure may be repeated at least twice, and the final product suspended in a nonpolar solvent such as hexanes.

The multi-metal composition may be used to convert hydrogen sulfide in a gas stream to hydrogen and sulfur. The gas stream may be a produced gas stream from a subterranean formation, natural gas that contains hydrogen sulfide, or from crude oil processing where sulfur is removed by hydrodesulferization units by treating with H₂. In the process, hydrogen sulfide is generated that can be treated by these methods. The gas stream may not be limited to these sources and may be used to convert hydrogen sulfide in a gas stream to hydrogen and sulfur regardless of the source.

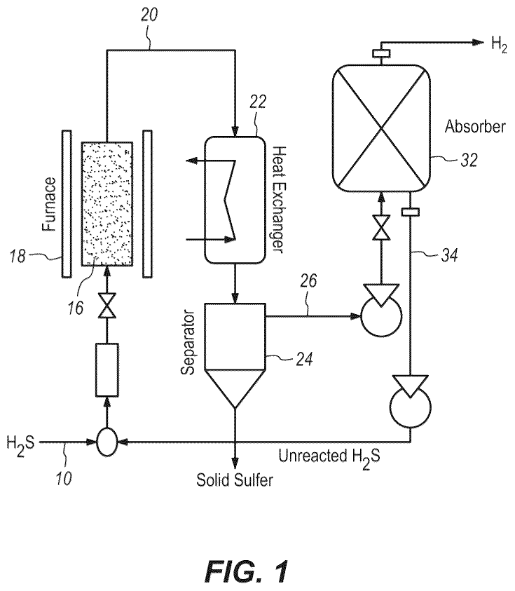

FIG. 1 shows a method for converting hydrogen sulfide in a gas stream 10 to hydrogen and sulfur via a thermocatalytic and/or thermochemical method. Gas stream 10 may be a produced gas stream. The conversion method may include a gas stream 10 comprising hydrogen sulfide. In some embodiments gas stream 10 may comprise other components such as natural gas, CO₂, CO, N₂, or the like. In some embodiments, gas stream 10 may consist essentially of hydrogen sulfide and an inert gas mixture. In some embodiments, gas streams comprising hydrogen sulfide may be separated from other components such as hydrocarbons, CO₂, CO, or water to avoid damage to the multi-metal composition. Gas stream 10 that consists essentially of hydrogen sulfide is a stream of gas that has had other components removed from the hydrogen sulfide gas stream but some components may still exist in small amounts. This stream of gas may be used without immediate degradation of the multi-metal composition. The conversion method may include flowing gas stream 10 through a multi-metal composition in column 16. Column 16 may be a fixed bed column, a moving bed column, a fluidized bed column, or a slurry column. Column 16 may contain or be packed with the multi-metal composition. The multi-metal composition in column 16 may include metal alloy sulfides or metal alloy oxides. In some embodiments, column 16 includes either metal alloy oxides or metal alloy sulfides but not both. Column 16 may be heated by furnace 18. Furnace 18 may heat via inductive heating, microwave heating, plasma cracking, microwave plasma cracking or be a solar furnace. In some embodiments, the gas stream may be heated before reaching column 16, in others it is not. It may be heated via inductive heating, microwave heating, plasma cracking, microwave plasma cracking, or solar furnace heating. In some embodiments gas stream 10, column 16, or both may be heated to a temperature range from about 400° C. to about 900° C., about 400° C. to about 800° C., about 400° C. to about 700° C., about 500° C. to about 600° C., about 400° C. to about 500° C., or about 400° C.

The interaction between the hydrogen sulfide and the multi-metal composition may comprise a decomposition reaction, sulfidation reaction, or both. In some embodiments, the multi-metal composition does not undergo sulfidation or only undergoes partial sulfidation. In some embodiments, column 16 does not need regeneration as it does not undergo sulfidation or only undergoes partial sulfidation. Some amount of sulfidization may be possible when gas stream 10 is heated or column 16 is heated below 400° C.

The chemical products of the interacting step may comprise hydrogen and sulfur or may consist essentially of hydrogen and sulfur. The product gas stream 20 may comprise hydrogen sulfide in a percentage no greater than about 1%, about 5%, about 10%, about 15%, about 20% about 25%, or about 50%. The product gas stream 20 may comprise hydrogen in a percentage of greater than 50%. The product gas stream 20 may comprise other components such as natural gas, CO₂, or N₂.

The sulfur may be separated from the hydrogen by condensing. Condensing may be done to prevent the reversible reaction between hydrogen and sulfur to make hydrogen sulfide. Product gas stream 20 may be fed into heat exchanger 22 which may lower the temperature of product gas stream 20 enough to prevent the reversible reaction or may lower the temperature to the point where the sulfur becomes a liquid before separating and turning to solid. The method may include a sulfur separator 24 to separate out solid sulfur. Sulfur separator 24 may collect condensed sulfur or may be one or more sulfur-adsorbing membranes, molecular sieves, or any suitable means to remove sulfur from hydrogen gas. The method may include a post-sulfur separator gas stream 26 that may be fed to a hydrogen separator 32. Hydrogen separator 32 may be a hydrogen membrane that only allows hydrogen to pass through it such as a palladium-based membrane, a polymer-based membrane, a metal-organic framework membrane, or any other suitable means for separating hydrogen. The method may include a hydrogen separator 32 without a sulfur separator 24. The separator 32 may also contain a scrubber for collecting unreacted hydrogen sulfide. The method may include separating hydrogen before separating sulfur. The method may include refeed gas stream 34. Refeed gas stream 34 may comprise hydrogen sulfide or consist essentially of hydrogen sulfide. Refeed gas stream 34 is refed to column 16 for further reaction. In some embodiments, the multi-metal composition may undergo partial or whole sulfidation and may be regenerated by heating to a temperature range about 400° C. to about 900° C. This process will generate sulfur.

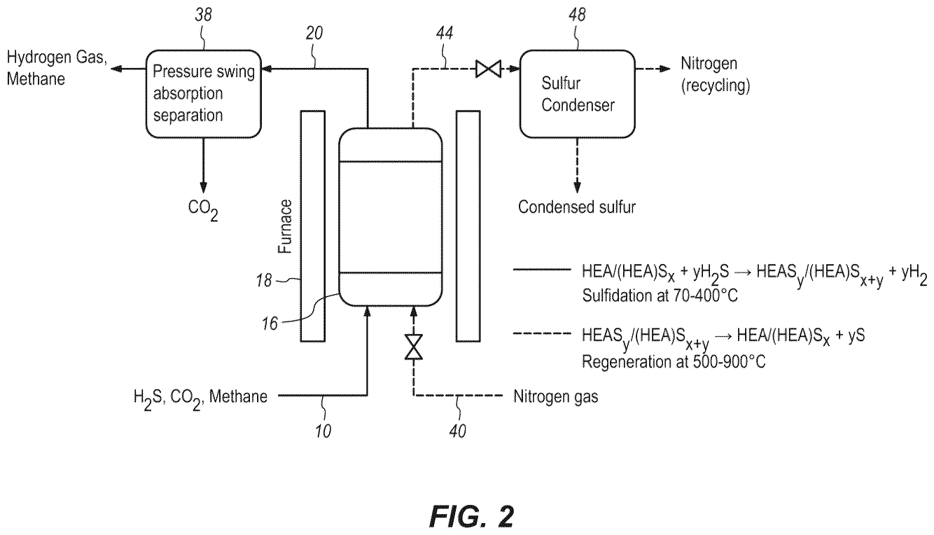

FIG. 2 shows a method for converting hydrogen sulfide in a gas stream 10 to hydrogen and sulfur via thermochemical decomposition. The conversion method includes a gas stream 10 comprising hydrogen sulfide. The method for converting hydrogen sulfide to hydrogen and sulfur may include gas feed 10. Gas stream 10 may be a produced gas stream. In some embodiments gas stream 10 includes other components such natural gas, CO₂, CO, or N₂. Gas stream 10 may be fed into column 16, which comprises the multi-metal composition. The multi-metal composition in column 16 may include metal alloy sulfides or metal alloy oxides. In some embodiments, column 16 includes either metal alloy oxides or metal alloy sulfides but not both. Column 16 may be heated by furnace 18. Gas stream 10 may be heated before being fed into column 10. In some embodiments gas stream 10, column 16, or both may be heated to a temperature range from about 50° C. to about 500° C., about 70° C. to about 500° C., about 100° C. to about 400° C., about 100° C. to about 300° C., or about 200° C. to about 300° C. Gas stream 10 may be fed into column 16 at a pressure ranging from about 0.5 atm to about 175 atm, about 1 atm to about 150 atm, about 1 atm to about 50 atm, about 1 atm to about 10 atm, about 5 atm to about 100 atm, or about 5 atm to about 50 atm.

The interaction between the hydrogen sulfide and the multi-metal composition may comprise a thermochemical decomposition reaction, a sulfidation reaction, or both. Column 16 may comprise at least one multi-metal composition designed to facilitate a reaction. In some embodiments, partial thermocatalytic reaction may happen where some hydrogen sulfide is directly converted to hydrogen and sulfur.

The products of the interacting step may comprise hydrogen and a higher metal sulfide alloy sulfide. The product gas stream 20 may comprise hydrogen at a percentage of at least about 1%, about 5%, about 10%, about 15%, about 20% about 25%, about 50%, about 60%, about 70%, about 80%, about 90%, about 95%, about 99%, or about 100%.

Product gas stream 20 may comprise CO₂, hydrogen gas, methane, or a combination thereof. The CO₂ may be separated from the methane and the hydrogen gas. The CO₂ may be separated from the methane and the hydrogen gas by pressure swing adsorber 38.

After the multi-metal composition has at least partially undergone sulfidation, column 16 may be regenerated. The regeneration process may include providing a regeneration gas 40, which may include an inert gas such as nitrogen, into column 16. Column 16 may be regenerated by heating at a temperature of about 500° C. to about 900° C. to remove at least some sulfur from the higher metal sulfide alloy sulfide. The regeneration process may remove sulfur and the regeneration product 44 sent through a valve to a sulfur condenser 48. Sulfur condenser 48 may include a heat exchanger to cool the sulfur, or direct or indirect cooling means to cool the sulfur. Sulfur condenser 48 may instead comprise one or more sulfur-adsorbing membranes, molecular sieves, or any suitable means to remove sulfur. The sulfur may be separated from regeneration product 44 for use as a new regeneration gas 40 that may be reused.

In one or more embodiments the reaction process may be represented by Equation 1 as shown in FIG. 4. The term “HEA” refers to a high entropy alloy. The term “high entropy” refers to the fact that these alloys have generally high entropy compared to known catalysts with bi- or tri-metal components. However, no specific magnitude for entropy is intended by this definition. The term “(HEA)Sₓ” refers to an HEA that has x moles of sulfur bound to it. The term x may be, but is not limited to, 1 or 2.

This first step includes interacting either HEA or (HEA)Sₓ with y moles of H₂S to produce HEAS_{y} that is now sulfidized or (HEA)S_{x+y} that is now a higher order sulfide. The temperature of the H₂S in the sulfidation reaction may be from about 70° C. to about 400° C. The reaction may produce y moles of hydrogen gas. The reaction may tie all the sulfur to the HEA or (HEA)Sₓ and hydrogen gas is the only gaseous product.

After the first step, a second step may be performed, which is represented by Equation 2 in FIG. 5. The second step is a regeneration step where HEASy or (HEA)S_{x+y} formed in the first step is regenerated back to HEA or (HEA)Sₓ. The regeneration may be performed by passing an inert gas such as nitrogen over or through the HEA or (HEA)Sₓ where the inert gas is at a temperature from about 500° C. to about 900° C. This may produce y moles of sulfur that is condensed and separated from the nitrogen gas.

### Embodiments Disclosed Herein Include the Following:

Embodiment A: a method comprising: providing a multi-metal composition comprising an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr; and interacting a gas stream comprising hydrogen sulfide with the multi-metal composition.
Embodiment B: a method comprising: providing a multi-metal composition comprising CrFeWNiMo, CrFeZnTiMo, MoNiCuZnCo, CrFeNiVMo, or CuFeNiVMo sulfide; and interacting a gas stream comprising hydrogen sulfide with the multi-metal composition.
Embodiment C: a multi-metal composition comprising: an alloy comprising at least five elements selected from the group consisting of Co, Cr, Fe, Mn, Ni, Al, Mg, Cu, Zn, Zr, Ru, Rh, Pd, Ag, W, Rc, Ir, Pt, Pd, Au, Ce, Yb, Sn, Ca, Bc, Mo, V, W, and Sr.

Each of embodiments A, B, and C may have one or more of the following additional elements in any combination:
Element 1: wherein the gas stream consists essentially of hydrogen sulfide.
Element 2: wherein the chemical products of the interacting step comprise hydrogen and sulfur.
Element 3: further comprising condensing the sulfur.
Element 4: further comprising separating the hydrogen.
Element 5: wherein the alloy further comprises sulfur.
Element 6: wherein the gas stream comprises natural gas, hydrocarbons, carbon dioxide, carbon monoxide, oxygen, nitrogen, or water.
Element 7: wherein the product of the interacting step comprises hydrogen and a higher metal sulfide alloy sulfide.
Element 8: wherein the gas stream further comprises CO₂ and hydrocarbons and the CO₂ is separated from the hydrocarbons and hydrogen.
Element 9: wherein the multi-metal composition is disposed on at least one column, the interacting step comprises the alloy undergoing sulfidation, and the method further comprises heating the column to remove at least some sulfur from the alloy.
Element 10: wherein the multi-metal composition is disposed on at least one column, the interacting step comprises the alloy undergoing sulfidation, and the method further comprises heating the column to remove at least some sulfur from the alloy.
Element 11: wherein the at least five elements are Cr, Fe, W, Ni, and Mo; Cr, Fe, Zn, Ti, and Mo; Mo, Ni, Cu, Zn, and Co; or Cr, Fe, Ni, V, and Mo.
Element 12: wherein the at least five elements are Cu, Fe, Ni, V, and Mo.
Element 13: wherein the multi-metal composition further comprises at least one support or at least one promoter.
Element 14: wherein the alloy further comprises at least one metal support or at least one metal promoter.
Element 15: further comprising at least one support or at least one promoter and wherein the composition is in the form factor of a mixture of the alloy and the at least one support or the at least one promoter.
Element 16: wherein the alloy comprises from about 0.1 atomic % to about 20 atomic % metal supporter or from about 0.1 atomic % to about 20 atomic % metal promoter.

To facilitate a better understanding of the present disclosure, the following examples of preferred or representative embodiments are given. In no way should the following examples be read to limit, or to define, the scope of the invention.

### EXAMPLES

Preferred examples are described in this section to aid in understanding this disclosure. This disclosure is not limited to the examples. The starting materials used in the following examples are all commercially available.

Example 1. Preparing Alloy [Cr_{0.2}Fe_{0.2}W_{0.2}Ni_{0.2}Mo_{0.2}] by Arc Melting. Equimolar amounts of Cr, Fe, W, Ni and Mo pure powder (99.9+%) were arc melted in an argon atmosphere on a water cooled copper hearth with a tungsten electrode. The polycrystalline button formed was turned several times and remelted to ensure a homogeneous sample. The ingot was cooled with liquid nitrogen and cryo milled −160+/−10° C., 6 h in an argon atmosphere to make an alloy [Cr_{0.2}Fe_{0.2}W_{0.2}Ni_{0.2}Mo_{0.2}] powder. The sample was characterized by X-ray diffraction (XRD), electron backscattered diffraction (EBSD) and dispersive X-ray spectroscopy (EDS).

Example 2. Preparing Alloy [Cr_{0.2}Fe_{0.2}Zn_{0.2}Ti_{0.2}Mo_{0.2}] by Mechanical Alloying. Equimolar amounts of Cr, Fe, Zn, Ti, and Mo pure powder (99.9+%, 40 micron) were mixed in a high energy planetary ball miller for 60 h together with milling media. Stearic acid was added to the mix as a process control agent. The alloy [Cr_{0.2}Fe_{0.2}Zn_{0.2}Ti_{0.2}Mo_{0.2}] powder formed from the process has a size of 0.5-10 micron.

Example 3. Preparing Alloy [Cr_{0.2}Fe_{0.2}Ni_{0.2}V_{0.2}Mo_{0.2}] by Solvo Thermal Reaction. Equimolar solutions of metal acetylacetonate of Cr, Fe, Ni, V and Mo were dissolved in a mixture of acetone and methanol and heated to 200° C. for 24 h in a sealed vessel. The solvent was evaporated, the material washed with hexane, and then the material was heated to 200° C. in an Argon atmosphere. It was then grinded to the required size for the separation of hydrogen sulfide into hydrogen and sulfur.

Example 4. Preparing Alloy Sulfide nanoparticles [Cu_{0.2}Fe_{0.2}Ni_{0.2}V_{0.2}Mo_{0.2}] S by Cation Exchange Reaction. Cu₂S particles were suspended in trioctyl phosphine and were added to a 100 ml round-bottom flask equipped with a magnetic stir bar, a reflux condenser, a gas flow adapter, an alcohol thermometer, and a rubber septum. To this was added 0.02 M exchange solutions of each FeCl₂, NiCl₂, VCl₃ and MoCl₅ prepared by dissolving each metal chloride salt in tg-oleyl amine, octadecene, and benzyl ether (2:1:1 ratio) prior to the reaction. The amount of each material was added to make equimolar amounts of the metal in the alloy. Then, this mixture was stirred, placed under a vacuum, and heated to 110° C. for 30 min. Then the reaction mixture was cycled three times with argon and vacuum and placed under an argon blanket. Under the argon blanket, the reaction was heated to 140° C. and held there for 60 min. The reaction mixture was then placed in an ice bath. Once the temperature of the reaction mixture was approximately 10-20° C., the reaction mixture was poured into a centrifuge tube, then a 1:1 mixture of IPA and acetone was added, followed by centrifugation and resuspension in toluene. This washing procedure was repeated twice, and the final red/brown product was suspended in hexanes.

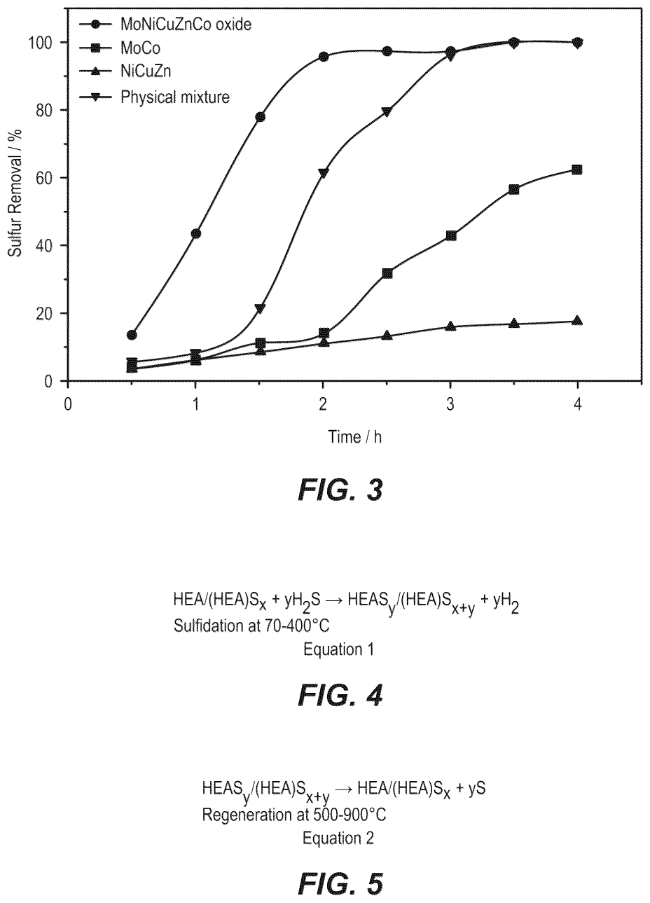

Example 5. Desulfurization by MoNiCuZnCo oxide versus other metals. A MoNiCuZnCo oxide with equimolar metal ratios was made through calcining at 900° C. To test the MoNiCuZnCo oxide, desulfurization tests were performed with this, a MoCo alloy, a NiCuZn alloy, and a physical mixture of Mo, Ni, Cu, Zn, and Co powders. The physical mixture of Mo, Ni, Cu, Zn, and Co was made by physically mixing the powders but not alloying them. As shown in FIG. 3, the MoNiCuZnCo oxide removed a higher percentage of sulfur and in less time than the MoCo and NiCuZn catalysts. FIG. 3 also shows that the mixture of Mo, Ni, Cu, Zn, and Co powders took longer to remove a similar percentage of sulfur from the gas stream. This example shows the effectiveness of MoNiCuZnCo oxide alloys over bi- and tri-metallic catalysts to remove sulfur. The example also shows that the alloy performed better than the physical mixture with the same metal components.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is the following:

1. A method comprising:
providing a multi-metal composition comprising an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr; and
interacting a gas stream comprising hydrogen sulfide with the multi-metal composition.

2. The method of claim 1, wherein the gas stream consists essentially of hydrogen sulfide.

3. The method of claim 1, wherein the chemical products of the interacting step comprise hydrogen and sulfur.

4. The method of claim 3, further comprising condensing the sulfur.

5. The method of claim 3, further comprising separating the hydrogen.

6. The method of claim 1, wherein the alloy further comprises sulfur.

7. The method of claim 6, wherein the gas stream comprises natural gas, hydrocarbons, carbon dioxide, carbon monoxide, oxygen, nitrogen, or water.

8. The method of claim 7, wherein the product of the interacting step comprises hydrogen and a higher metal sulfide alloy sulfide.

9. The method of claim 6, wherein the gas stream further comprises CO₂ and hydrocarbons and the CO₂ is separated from the hydrocarbons and hydrogen.

10. The method of claim 1, wherein the multi-metal composition is disposed on at least one column, the interacting step comprises the alloy undergoing sulfidation, and the method further comprises heating the column to remove at least some sulfur from the alloy.

11. The method of claim 6, wherein the multi-metal composition is disposed on at least one column, the interacting step comprises the alloy undergoing sulfidation, and the method further comprises heating the column to remove at least some sulfur from the alloy.

12. The method of claim 1, wherein the at least five elements are Cr, Fe, W, Ni, and Mo; Cr, Fe, Zn, Ti, and Mo; Mo, Ni, Cu, Zn, and Co; or Cr, Fe, Ni, V, and Mo.

13. The method of claim 6, wherein the at least five elements are Cu, Fe, Ni, V, and Mo.

14. A method comprising:
providing a multi-metal composition comprising CrFeWNiMo, CrFeZnTiMo, MoNiCuZnCo, CrFeNiVMo, or CuFeNiVMo sulfide; and
interacting a gas stream comprising hydrogen sulfide with the multi-metal composition.

15. The method of claim 14, wherein the multi-metal composition further comprises at least one support or at least one promoter.

16. A multi-metal composition comprising:
an alloy comprising at least five elements selected from the group consisting of Co, Cr, Fe, Mn, Ni, Al, Mg, Cu, Zn, Zr, Ru, Rh, Pd, Ag, W, Re, Ir, Pt, Pd, Au, Ce, Yb, Sn, Ca, Be, Mo, V, W, and Sr.

17. The composition of claim 16, wherein the alloy further comprises at least one metal support or at least one metal promoter.

18. The composition of claim 16, further comprising at least one support or at least one promoter and wherein the composition is in the form factor of a mixture of the alloy and the at least one support or the at least one promoter.

19. The composition of claim 17, wherein the alloy comprises from about 0.1 atomic % to about 20 atomic % metal supporter or from about 0.1 atomic % to about 20 atomic % metal promoter.

20. The composition of claim 16, wherein the at least five elements are Cr, Fe, W, Ni, and Mo; Cr, Fe, Zn, Ti, and Mo; Mo, Ni, Cu, Zn, and Co; Cr, Fe, Ni, V, and Mo; or Cu, Fe, Ni, V, and Mo.
